(19) United States
(12) Patent Application Publication
(10) Pub. No.: US 2013/0083045 A1
(43) Pub. Date: Apr. 4, 2013

(54) APPARATUS TO CONTROL DISPLAY OF CONTENT AND METHOD THEREOF

(71) Applicant: David Berfanger, Vancouver, WA (US)

(72) Inventor: David Berfanger, Vancouver, WA (US)

(21) Appl. No.: 13/249,827

(22) Filed: Sep. 30, 2011

(51) Int. Cl. G06T 1/00

(52) U.S. Cl. 345/522

(57) ABSTRACT

Apparatuses, systems, and methods to control display of content between a client device and a display system are provided herein. The apparatus includes a client engine, a resource engine, a display engine, and a control unit. The client engine connected to a client device to receive a display request therefrom. The resource engine is connected to a resource broker to transmit a content request to the resource broker, the content request including parameters corresponding to the content resource and receive a representation of content from the content resource associated with the resource broker. The display engine is connected to the display system to transmit a display instruction, including the representation of the content to the display system. The control unit is connected to the client engine, the resource engine, and the display engine to compose the content request and the display instruction.

### CROSS REFERENCE TO RELATED APPLICATIONS

This application is related to commonly-owned patent application Ser. Nos. 13/048,611 (Attorney Docket No. 201005857US01), entitled “SYSTEM AND METHOD OF PROCESSING CONTENT USING A UNIFORM RESOURCE IDENTIFIER” filed Mar. 15, 2011 by David Berfanger et al., and 13/079,470 (Attorney Docket No. 201005838US01), entitled “SYSTEMS AND METHODS FOR MANAGING A PRINT JOB” and filed Apr. 4, 2011 by Patruni Satish Kumar, et al. The related applications are incorporated herein by reference in their entirety.

### BACKGROUND

Client devices interact with resources that store and manipulate content and with display systems that display content. Client devices typically include interfaces and engines that allow users to view the content on the client device and make selections to manipulate the content. To display the content, a representation of the content is usually obtained and manipulated by the client device and then transmitted to the display system for display.

### BRIEF DESCRIPTION OF THE DRAWINGS

Non-limiting examples of the present disclosure are described in the following description, are read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a system useable with a client device and display system according to an example;

FIG. 2 illustrates a schematic diagram of the system of FIG. 1 useable with a client device and a display system according to an example;

FIG. 3 illustrates a block diagram of an apparatus according to an example;

FIGS. 4-5 illustrate block and sequence diagrams of the system of FIG. 1 according to examples;

FIG. 6 illustrates a display request according to an example;

FIG. 7 illustrates a content request according to an example;

FIG. 8 illustrates a resource request and instruction according to an example;

FIG. 9 illustrates a resource message according to an example;

FIG. 10 illustrates a message with a representation of the content according to an example;

FIG. 11 illustrates a display instruction according to an example;

FIGS. 12-13 illustrate block and sequence diagrams of the system to prepare a display request according to an example; and

FIG. 14 illustrates a method to display content according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Requests to display content are typically initiated by a client device. The client device connects to a resource, such as a remote server or local file system, and obtains a representation of the content, for example, encoded image data. The client device then manipulates the representation of the content, using for example an interactive user interface on the client device. After the manipulation of the representation of the content is complete, the client device connects to a peripheral device, such as a printer, or a display device, such as a monitor, and transmits the manipulated content representation for display. The interactions between the client device, the resource and the display device may include multiple iterations of manipulations, which may require the client device to receive and/or to store multiple versions of the content. Furthermore, transmission delays may occur due to connections between the devices, the size of the files, and/or the limitations of the client device.

In examples, apparatuses, systems, and methods to control display of content between a client device and a display system are provided herein. The apparatus includes a client engine, a resource engine, a display engine, and a control unit. The client engine is connected to a client device to receive a display request therefrom. The display request includes a set of parameters corresponding to a content resource, a display system, and a display setting. The resource engine is connected to a resource broker to transmit a content request to the resource broker and receive a representation of the content from the content resource via the resource broker. The content request includes the set of parameters corresponding to the content resource. The display engine is connected to the display system to transmit a display instruction, including the representation of the content, to the display system. The control unit is connected to the client engine, the resource engine, and the display engine to compose the content request and the display instruction. The apparatus interacts with the resource broker and the display system based on the information contained in the display request in order to display the representation of the content in a manner desired by the user, but without requiring the user device to download or store the representation of the content.

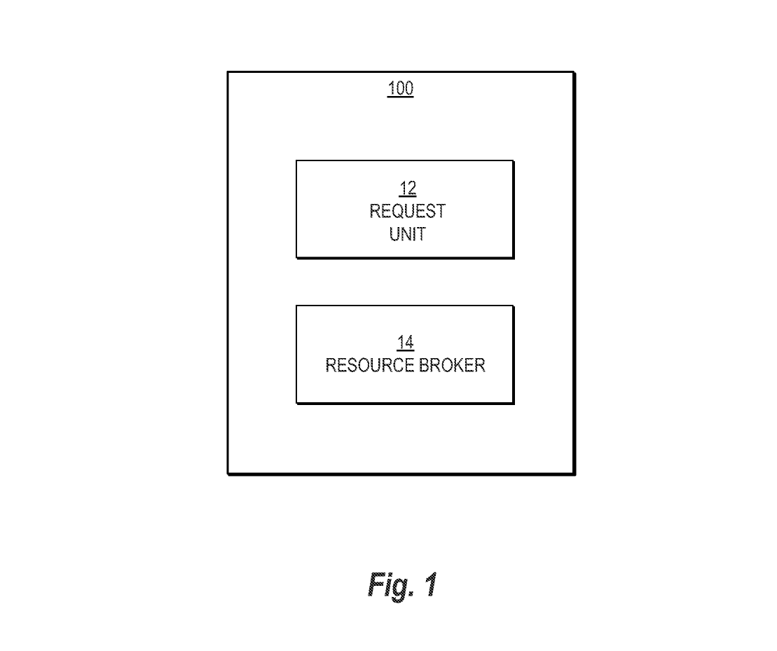

FIG. 1 illustrates a block diagram of a system 100 useable with a client device and a display system according to an example. The system 100 includes a request unit 12 and a resource broker 14. The request unit 12 controls display of content, such as electronic content between a client device and a display system. The resource broker 14 obtains a representation of the content from the content resource according to the content request, which includes a parameter corresponding to a content resource and optionally a service resource for manipulating the representation of the content. The request unit 12 and the resource broker 14 are connected to one another. For example, the request unit 12 and the resource broker 14 may be separate servers connected to one another and/or a single server with separate functions and/or engines.

The term content is used herein to refer to a representation of an available resource. For example, the content may be an electronic representation of a resource, such as an object, photograph, book, painting, sound, and/or movie. The content may be obtained from one or both of local and remote sources, such as computer files, network resources, web services, image scanners, microphones, webcams, digital cameras, and/or game systems.

The term display is used herein to refer to the presentation of content, for example, to the viewer of a computer display or a physical print. Further, the content may be electronic content capable of being manipulated prior to being displayed on one or both of peripheral devices and remote devices, such as computer monitors, televisions, projectors, printers, printing services, tape drives, audio speakers, mobile devices, mass storage devices, and storage services.

For example, the request unit 12 receives a display request from the client device. The display request includes a content request and a parameter indicating the manner of display desired by the user. Further the request unit 12 negotiates the content request with the resource broker 14, and the request unit 12 negotiates a display instruction with the display system. The request unit 12 transmits the display instruction to the display system. The display instruction includes the representation of the content obtained from the resource broker 14 and the parameter indicating the manner of display desired by the user. It is important to note that the display request, the content request, the display instruction, and all other messages transmitted between elements of the system 100 to negotiate requests, instructions, and messages are stateless and do not requires an external data store or session to be maintained. Therefore, each request, instruction, and message contains all of the state information necessary to fulfill the request. In various embodiments, a response to a request, instruction or message can be obtained from prior cached results rather than causing the request, instruction, or message to be resent. Conversely, the response to sending a request, instruction, or message can be cached for future retrieval to improve scalability and/or performance.

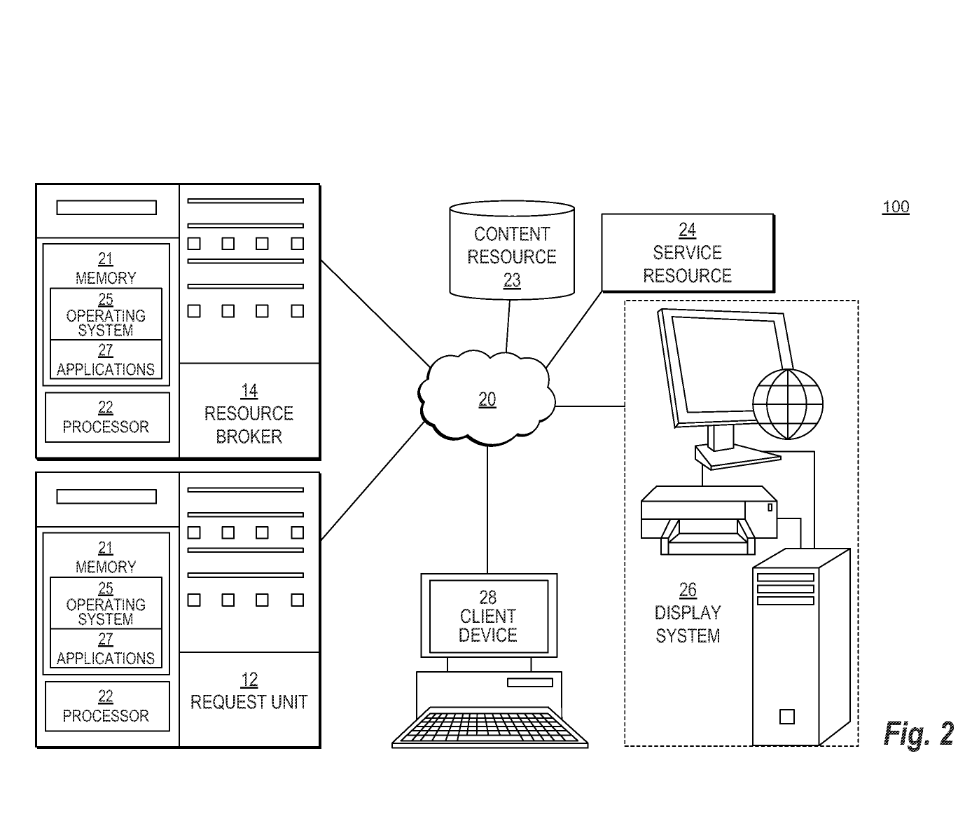

FIG. 2 illustrates a schematic diagram of the system 100 of FIG. 1 useable with a display system 26 and a client device 28 according to an example. The system 100 includes a request unit 12 and a resource broker 14 connected via a link 20. The link 20 further connects a content resource 23, a service resource 24, a display system 26, and a client device 28 to the request unit 12 and the resource broker 14.

The link 20 represents generally at least one of a cable, wireless, fiber optic, local, and remote connections via a telecommunication link, an infrared link, a radio frequency link, or any other connectors or systems that provide electronic communication. The link 20 may include, at least in part, an intranet, the Internet, or a combination of both. The link 20 may also include intermediate proxies, routers, switches, load balancers, and the like.

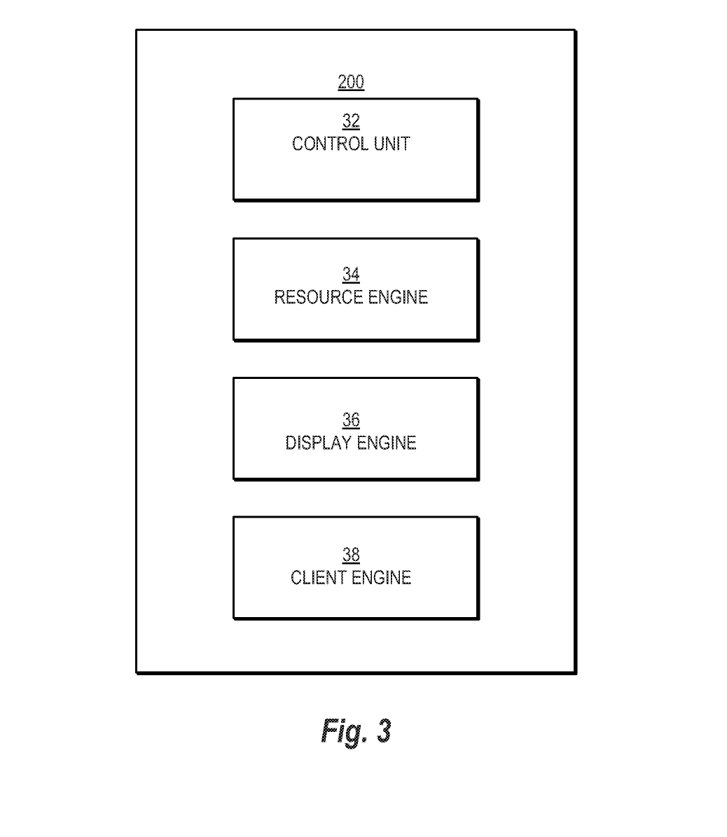

FIG. 3 illustrates a block diagram of an apparatus according to an example. For example, the apparatus is a request unit 12 that includes a control unit 32, a resource engine 34, a display engine 36, and a client engine 38.

The client engine 38 is connected to a client device 28 to receive a display request therefrom. The display request includes a content request and describes the manner of display desired by the user, such as a display system and associated display settings. The content request identifies a content resource and optionally a service resource to be used to manipulate the representation of the content according to instructions contained in the set of parameters corresponding to the service resource. Additional parameters to identify resources are also allowed in the content request. For example, multiple service resources can be identified for providing complex manipulations of the representation of the content from a content resource. In other examples, multiple content resources can be identified to be combined by the service resources into a single representation of the content.

The resource engine 34 is connected to a resource broker 14. The resource engine 34 transmits a content request to the resource broker 14 and receives a representation of the content from the resource broker 14. The content request includes, for example, parameters corresponding to the content resource 23 and optionally the service resource 24. The parameter corresponding to the content resource identifies the content source from which to obtain the representation of the content. The parameter corresponding to the service resource 24 includes instructions that manipulate, transform, and/or edit (hereinafter “manipulate”) the representation of the content from the content resource. For example the representation of the content from the content resource may include image data with various attributes, such as encoding format, resolution, cropping, and color rendering; and the service resource instructions may designate how to alter at least one of the attributes of the image data. The representation of the content obtained from the resource broker 14 then includes the manipulations according to the service resource 24 instructions.

Parameters contained in the content request include instructions to obtain the representation of the content and optionally manipulate the representation of the content, such as transforming and rendering the obtained representation of the content to be more amenable to a particular application associated with the display system 26. In other examples, a service resource 24 may include content understanding or analysis services that translate the representation of the content into alternate formats. For example, an image of a scanned document can be analyzed by an optical character recognition service to deliver a textual representation of the image. In another example, a low resolution video stream can be enhanced to be more appropriate for display on a high-definition display. In yet another example, multiple content resources can be collected, arranged and rendered into a single image for display.

The display engine 36 is connected to the display system 26. The display engine transmits a display instruction to the display system 26. The display instruction includes the representation of the content obtained from the resource broker 14 and the parameters describing the manner of display desired by the user, such as a display system 26 and associated display settings. The display engine 36 also receives status messages from the display system 26.

The control unit 32 is connected to the resource engine 34, the display engine 36, and the client engine 38. The control unit 32 extracts the set of parameters corresponding to the content resource 23, the service resource 24, the display system 26, and the display setting. The control unit 32 uses the information extracted from the display request to compose the content request and the display instruction.

The control unit 32 also adjusts at least one of the parameters corresponding to the service resource 24, the content resource 23, the display system 26, and the display settings. For example, the control unit 32 may compose an updated content request and/or display instruction to concatenate at least one of an additional parameter value and/or provide an updated parameter value. The updated content request and/or display instruction may be needed to refine the content request based on the content requested and/or the display system 26 selected. The update may be provided to the user using, for example, an actuation feature to allow selection of the adjusted parameters.

The control unit 32 and the display engine 36 may also receive messages from the display system 26 and provide messages to the user via the client device 28 and/or additional devices. For example, an asynchronous message instruction contacts a user via, for example, a text message, email message, and/or instant message. The asynchronous message includes at least one of a completion message in response to a determination that the display system 26 has executed the display instruction, an error message in response to a determination that the display system 26 failed to execute the display instruction, and an actuation feature for initiating a display request with at least one of the set of parameters modified.

Further, the display engine 36 receives a status message providing a status of the display request from the display system 26. The control unit 32 provides the status message to the client engine 38. The client engine 38 transmits the status message to the client device 28. The status message includes at least one of an acceptance message in response to a determination that the display system 26 can execute the display instruction, a denial message in response to a determination that the display system 26 cannot execute the display instruction, and an actuation feature for initiating a display request with at least one of the set of parameters modified.

Referring back to FIG. 2, the request unit 12 and the resource broker 14 may further include a memory 21 and a processor 22. The request unit 12 may for example be included in a computer system, such as a server. The control unit 32, resource engine 34, display engine 36, and the client engine 38 of the request unit 12 represent generally any combination of hardware and/or software to control display of content between a client device 28 and a display system 26, as described with reference to FIG. 3. For example, the request unit 12 in FIG. 2 includes a memory 21 to store a set of instructions to control the content, and a processor 22 to execute the set of instructions. The processor 22 represents generally any processor configured to execute program instructions stored in memory 21 to perform various specified functions.

The resource broker 14 may also be included in a computer system, such as a server. The resource broker 14 represents generally any combination of hardware and/or software to obtain the representation of the content. For example, the resource broker 14 in FIG. 3 includes a memory 21 to store a set of instructions to obtain the representation of the content, and a processor 22 to execute the set of instructions. The processor 22 represents generally any processor configured to execute program instructions stored in memory 21 to perform various specified functions.

The memory 21 is illustrated to include an operating system 25 and applications 27. The operating system 25 represents a collection of programs that when executed by the processor 22 serve as a platform on which applications 27 may run. Examples of operating systems 25 may include various versions of Microsoft's Windows®, Apple's Mac OS®, and Google's Android™.

Applications 27 represent program instructions that when executed by the processor 22 functions as an application. In the resource broker 14, the applications 27 function to obtain a representation of the content. Similarly, in the request unit 12, each of the engines function as an application based on the program instructions associated therewith. For example, in the client engine 38, the applications 27 function as a mediator between the client device 28 and the request unit 12. Similarly, in the display engine 36, the applications 27 function as a mediator between the display system 26 and the request unit 12, and in the resource engine 34, the applications 27 function as a mediator between the resource broker 14 and the request unit 12.

The executable program instructions stored in memory 21 represent program instructions that when executed by a processor 22 cause the implementation of the control unit 32, the resource engine 34, the display engine 36, and the client engine 38. The executable instructions stored may include the set of instructions from the memory 21 and/or a database external to the request unit 12. In response to the software being loaded, instructions may be provided to the processor 22. The processor 22 executes the instructions to control display of content between the client device 28 and the display system 26.

Referring to FIGS. 2-3, the request unit 12 and the resource broker 14 are described as combinations of hardware and/or programming. The hardware portions may include the processor 22. The programming portions may include the operating system 25, applications 27, and/or combinations thereof. The programming may be processor executable instructions stored on a tangible memory media and the hardware may include a processor 22 to execute the instructions. The memory 21 may store program instructions that when executed by the processor 22 cause the processor 22 to perform the program instructions. The memory 21 may be integrated in the same device as the processor 22 or it may be separate but accessible to that device and processor 22.

In some examples, the program instructions may be part of installation software that can be executed by the processor 22 to perform a method using the system 100. The memory 21 may be a portable medium such as a CD, DVD, or flash drive or a memory maintained by a server from which the installation software can be downloaded and installed. In other examples, the program instructions may be part of an application or applications already installed in the product. In further examples, the memory 21 may include integrated memory such as a hard drive.

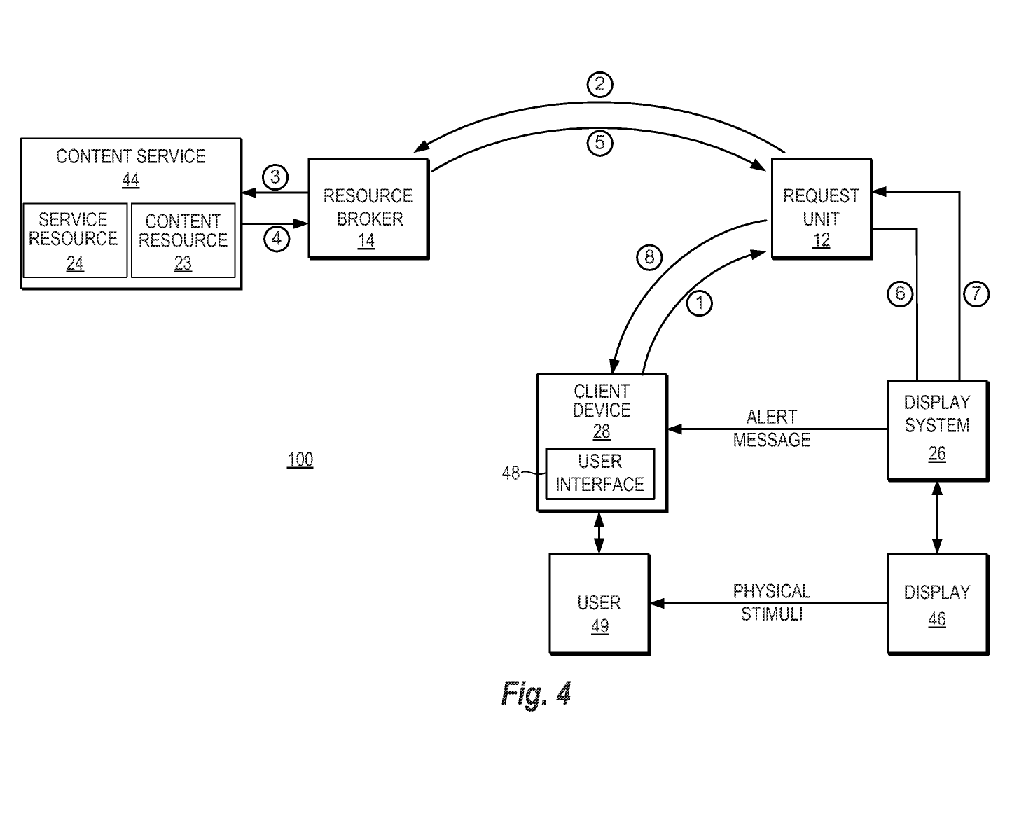

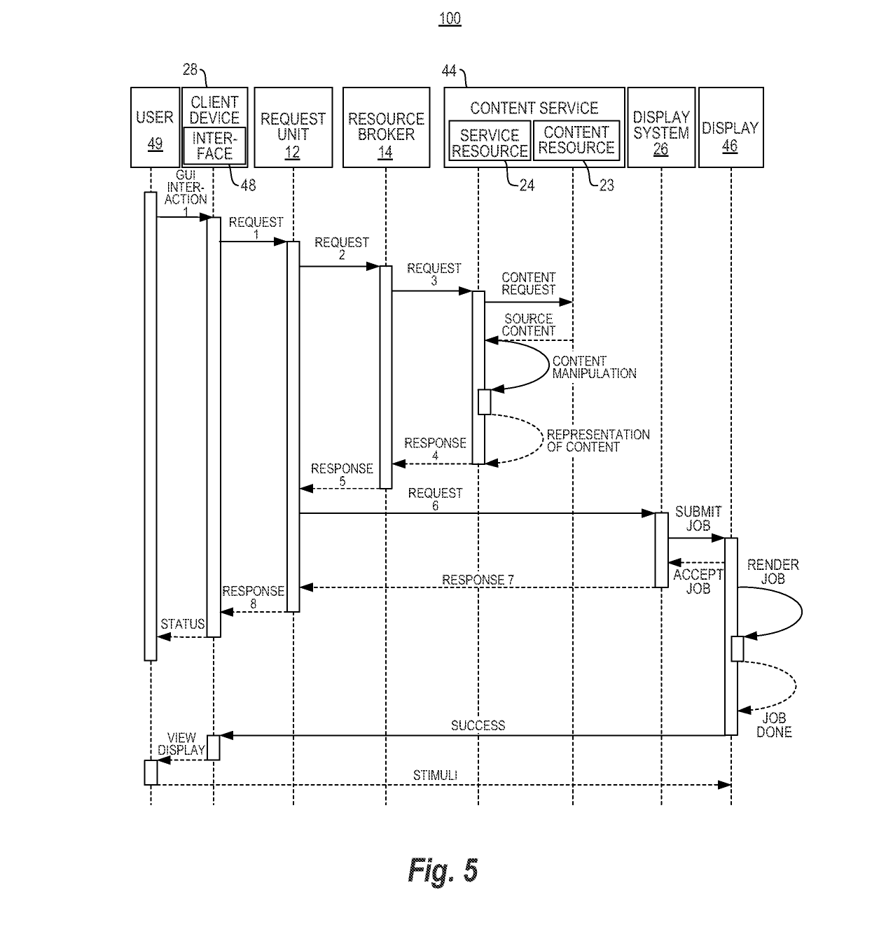

FIGS. 4-5 illustrate block and sequence diagrams of the system 100 of FIG. 2 according to examples. Referring to FIG. 4, a block diagram of the system 100 illustrates interactions between the request unit 12 and the resource broker 14, the display system 26, and/or the client device 28. The block diagram of FIG. 4 also illustrates interactions between the resource broker 14 and the content service 44 including the content resource 23 and the service resource 24. FIG. 5 illustrates a sequence diagram of the interactions of FIG. 4. Requests 1-3 and 6 and responses 4-5 and 7-8 are illustrated and described in FIGS. 4-5 as providing network communications between various components of the system 100. The requests and/or responses may be representative of other types of component interactions for example, communications between components implemented as different processes on a single computing device, such as pipes, shared memory, and memory-mapped files; or interactions between components integrated into a single process, such as function calls and memory accesses. Moreover, in some examples, the requests and/or responses could be representative of a plurality of requests and/or responses.

FIG. 4 is a block diagram illustrating interactions within the system 100 of FIG. 2. A user 49 may request content, such as a content resource for display on a display system 26 by interacting with a user interface 48. For example, the user interface 48 may include a graphical user interface (GUI), such as a monitor of a computer screen with a web browser displayed thereon. The user 49 may identify content and specify how the content should be displayed. The display request is fulfilled through a multi-device conversation comprising a series of transactions between the client device 28, a request unit 12 (e.g., host server, or display control interface), a resource broker 14 (e.g., cloud service or personal computer), one or several content services 44 (e.g., social networking sites, photo sharing sites, local storage, content processing services, or local processing resources), and a display device or display system 26 (e.g., network printer or media router). FIG. 5 is a sequence diagram corresponding to FIG. 4.

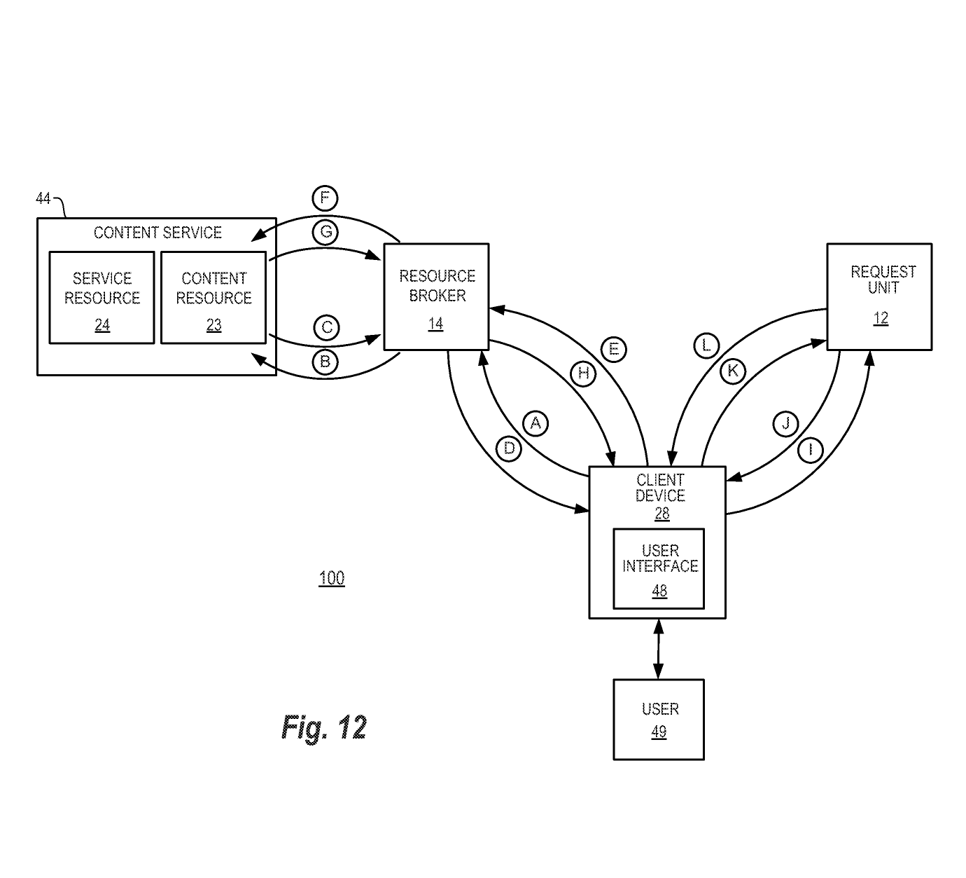

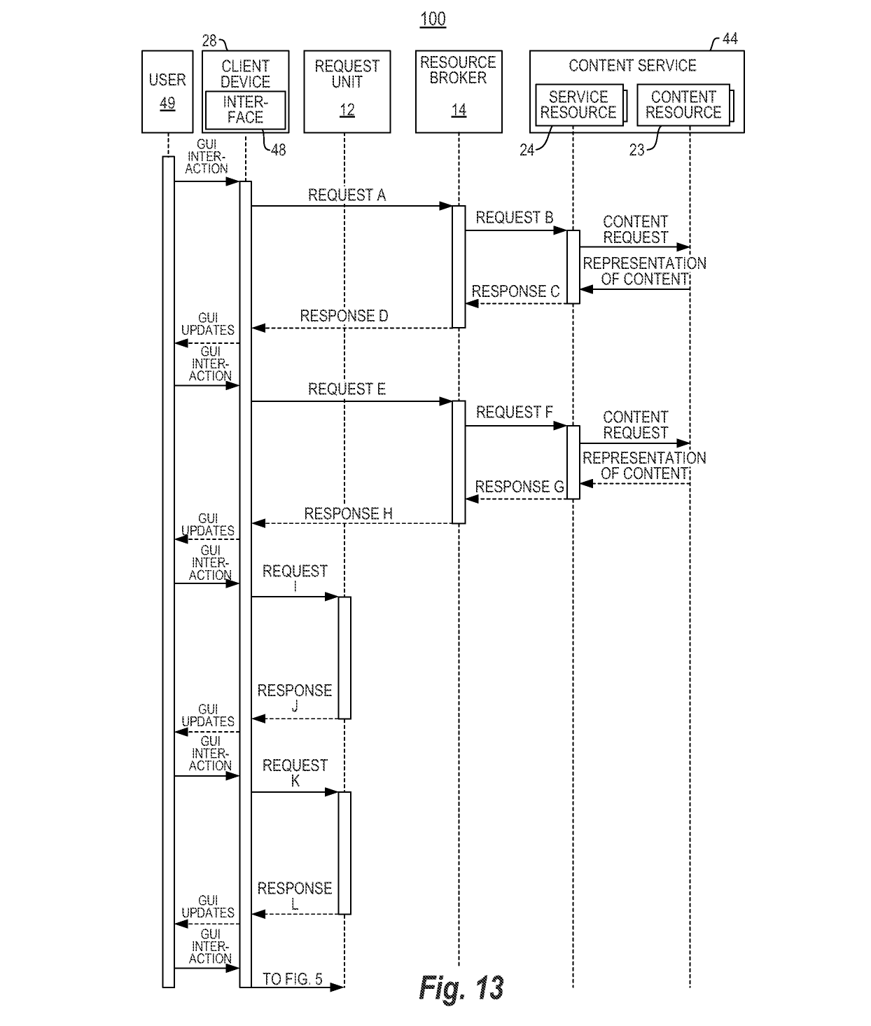

Referring to FIGS. 4-5, request 1 illustrates the request unit 12 receiving a display request from a client device 28. The display request is composed based on previous interactions between the client device 28 and the resource broker 14. The client device 28 may be provided with an actuation feature to transmit the display request to the request unit 12, such as illustrated in FIGS. 12-13. The display request may be initiated by, for example, a user 49 via a user interface 48, such as a web browser. The user interface 48 is integrated within and/or connected to the client device 28 to communicate with at least one of the resource broker 14 and the request unit 12. Request 1 identifies a representation of the content such as, an image obtained from the content resource, such as a data store, that is associated with the content service 44. Request 1 further identifies a content request for manipulating the representation of the content by an identified service resource 24 associated with the content service 44, a display system 26 (or target display device 46) and display settings for rendering the representation of the content.

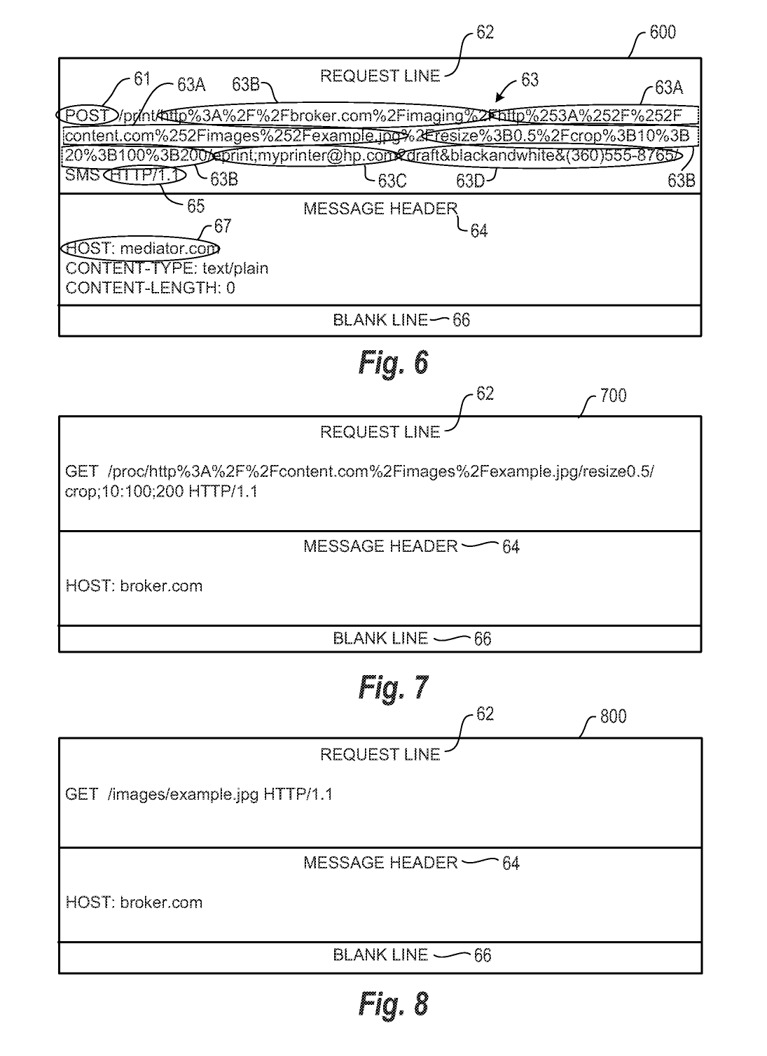

FIG. 6 illustrates a display request 600 according to an example. The display request 600 illustrated is a Hypertext Transfer Protocol (HTTP) requests for print jobs. The full syntax may vary, but the display request 600 of FIG. 6 may be interpreted as a postfix notation in which operators, such as the parameters corresponding to the service resources 63B, are preceded by their operands, such as the parameters corresponding to the content resource 63A. Thus, the output of the display request 600 can be predicted by conceptualizing the execution of the operators in terms of pushdown automata. Operators pop their inputs off an operand stack and then push their results back on, where an implicit response operator removes the final result from the stack, responding with the corresponding representation of the content as manipulated.

Referring to FIG. 6, the display request 600 includes a request line 62 and a message header 64, followed by a blank line 66. In other examples, a message body 68 may be included after the blank line 66. For example, the message body 68 may include text, an image, and/or query data. The example request line 62 has three parts, separated by spaces. The three parts include a method name 61, such as POST; a resource identification link 63, such as path and query components of a Uniform Resource Identifier (URI); and a HTTP version 65, such as HTTP/1.1. The resource identification link 63 includes the set of parameters corresponding to the content resource 63A, the service resource 63B, the display system 63C, and the display setting 63D. For example, in FIG. 6, the display request 600 includes a set of parameters encoded therein. The set of parameters include the content resource 63A, the service resource 63B, the display system 63C, such as a network enabled printer with an email address, and the display setting 63D, such as print settings of letter, draft, with alert messages forwarded via text message to a mobile phone number. All the information needed to make a request to obtain the content resource 23 from the resource broker 14 and all the information to display the representation of the content on a display system 26 are provided in the display request 600.

The message header 64 includes a host name 67, which refers to the destination of the display request 600. In FIG. 6 the host name 67 refers to mediator.com which is the address of the request unit 12. In examples that include a message body 68, the use of the message body 68 is determined by the URI. For example, the representation of the content may be provided in a message body 68. In the instance when the representation of the content is in the message body 68, the client device 28 may have obtained the representation of the content from an independent source.

After receiving request 1, the request unit 12 composes and transmits a content request to the resource broker 14, illustrated as request 2. The content request obtains a representation of the content and any optional manipulations, such as a resized and/or cropped version of an image that is maintained by, for example, a data store that is associated with the content service 44. For example, the request unit 12 can compose and transmit the content request from the display request 600 according to the methods described in FIG. 7.

FIG. 7 illustrates a content request 700 according to an example. The content request 700 is an HTTP request corresponding to request 2 in FIGS. 4-5, and similar to the display request 600 described above, the content request 700 includes a request line 62 and a message header 64 followed by a blank line 66. The request line 62 has three parts, separated by spaces: a method name “GET,” a local identifier of the requested content service 44, and the version of HTTP “HTTP/1.1.” The illustrated content request 700 identifies the parameters corresponding to the content resource 63A to be printed from, for example a data store and two service resources 63B providing instructions to manipulate the representation of the content prior to printing. All the information needed to obtain the representation of the content from the resource broker 14 is provided in the content request 700. In other examples, a message body 68 can be included after the blank line 66. For example, the message body 68 may include text, an image, and/or query data forwarded from the display request 600.

In request 3, the resource broker 14 transmits a resource request and instruction to a content service 44. FIG. 8 illustrates the resource request and instruction 800 according to an example. FIG. 8 illustrates an example of an HTTP request corresponding to request 3 in FIGS. 4-5 includes a request line 62 and a message header 64 followed by a blank line 66. The request line 62 has three parts, separated by spaces: a method name “GET,” a local identifier of the content resource 23, and the version of HTTP “HTTP/1.1.” For example, the content resource 23 is stored in a data store at http://content.com/images/example.jpg.

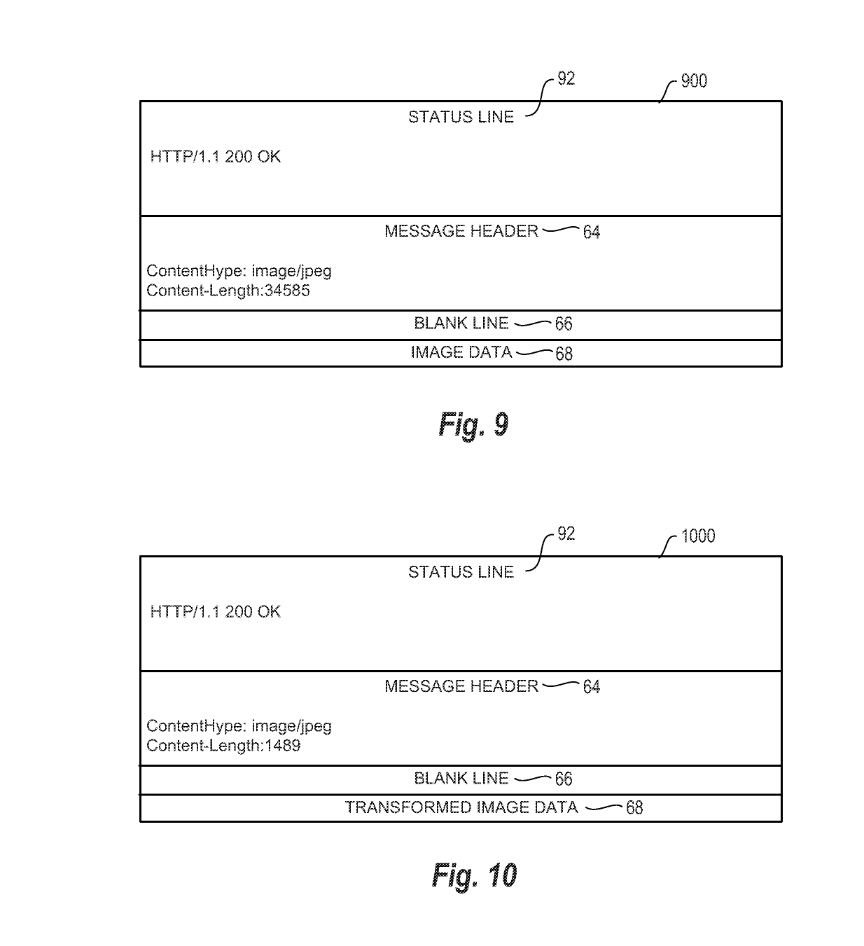

The resource request and instruction 800 provides the resource broker 14 with a representation of the content in response 4. The representation of the content is received from the content service 44 as a resource message and includes the parameters corresponding to the content resource 63A from, for example, a data store and a parameter corresponding to the service resource 63B instruction. FIG. 9 illustrates the resource message 900 according to an example. The resource message 900 is illustrated as an HTTP response corresponding to response 4 in FIGS. 4-5. In FIG. 9, the HTTP response includes a status line 92, a message header 64, a blank line 66, and a message body 68 containing the representation of the content. Upon receiving the resource message 900, the resource broker 14 can transmit a resource instruction to the service resource 24 with instructions to manipulate the representation of the content using the service resource 63B identified by request 2.

In examples in which the content request 700 includes a message body 68, the use of the message body 68 is determined by the URI. For example, the representation of the content may be provided in the content request 700 in a message body 68. In the instance when the representation of the content is in the message body 68, the resource broker 14 may forward the representation of the content to the service resource 63B identified by request 2. After manipulating the representation of the content with instructions corresponding to the service resource 24, the resource broker 14 obtains and transmits a message that includes the representation of the content with any manipulations to the request unit 12, illustrated as response 5.

In response 5, the resource broker 14 provides the representation of the content to the request unit 12. FIG. 10 illustrates a message 1000 with the representation of the content from a content resource 23 according to an example. The message 1000 with the representation of the content is illustrated as an HTTP response corresponding to response 5 in FIGS. 4-5 and includes a status line 92, a message header 64, a blank line 66, and a message body 68 containing the representation of the content.

After receiving the representation of the content in response 5, the request unit 12 composes and transmits a display instruction, such as an email message, to the display system 26 as request 6. The display instruction includes the representation of the content, as well as the identity of the display system 26 and any display settings 63D that were provided in request 1. For example, the display system 26 may be a printer and/or a video display on an internet-connected television.

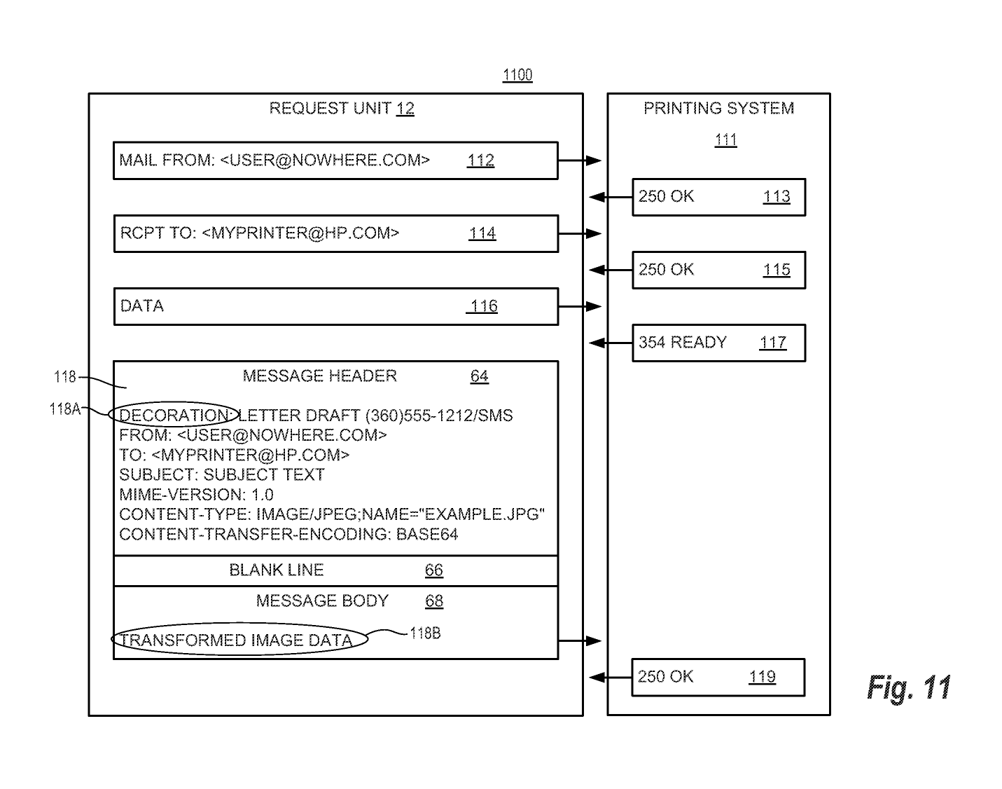

FIG. 11 illustrates a display instruction 1100 according to an example. The display instruction 1100 is a print request sent to a printer (request 6 in FIGS. 4-5), and is illustrated as an email message to the printing system 110, i.e., a display system 26. All the information needed to provide the representation of the content to the display system 26 with the display settings 63D is provided in the display instruction 1100. The printing system 111 as illustrated to include an integrated email server, but may include at least one remote email server. Moreover, other messaging methods such as, Internet Printing Protocol (IPP)) may be utilized. To send the message, the request unit 12 negotiates a connection to the display system 26, and identifies a request unit email address 112 (i.e., the address of the sender), such as MAIL FROM:<sender address>. The display system 26 responds with an acknowledgment message 113, which the request unit 12 uses to identify a peripheral email address 114 (i.e., the address of the recipient), such as “RCPT TO:<recipient address>.” The display system 26 responds with another acknowledgment message 115.

In response, the request unit 12 provides a data request 116 to start transmitting the display instruction (email message) e.g., “DATA.” The display system 26 responds with a data instruction message 117 of “Ready” and may also request that the request unit 12 start the input for the display instruction, and to end the input with a specific ending identifier, such as a carriage return, line feed, a period and another carriage return, line feed “<CRLF>.<CRLF>.” In response, the request unit 12 provides the display instruction data 118 to the display system 26, including the specific ending identifier. In response, the display system 26 provides an acknowledgment of reception of the display instruction 119. After delivering a last response, the printing system closes the connection. Upon accepting the message, the printing systems may produce a physical print, notifying thereafter the user agent of success or failure via an asynchronous alert method, such as an email or text message. The asynchronous alert method may include an asynchronous message according to a parameter transmitted with the display request 600.

In FIG. 11, the display instruction data 118 comprises an optional header field called “DECORATION” 118A comprising the provided print settings. Further the message header 64 contains information regarding the content 1188 for the print job, which is encoded in the message body 68. In examples, both during and after the interaction illustrated in FIG. 11, the display system 26 can refuse delivery of the message for various reasons, such as invalid permissions and/or malformed message content. In either case, the display system 26 can then notify the request unit 12 of a rejection or an acceptance via a synchronous message cascaded back through the response chain.

Referring back to FIGS. 4-5, the display system 26 includes a display system 26 and has a display 46 associated therewith. The display 46 may include a monitor screen, projector screen, and/or a media to be printed on. In the example display request 600, the display system 26 is a printer with the printer being the display system 26 and the display 46 being the media that the image is printed on. The content service 44 contains the content resource 23 in, for example, a data store, and the service resource 24 for manipulating and/or transforming the content resource 23 prior to printing.

After the display instruction 1100 is accepted by the display system 26, the display system 26 produces content for display and generates an observable display 46, such as an image placed on a screen and/or printed on media. The observable display is illustrated as the “PHYSICAL STIMULI” in FIG. 4. After the content is displayed or alternatively an error occurs, the display system 26 may send an asynchronous message, such as an email or text message, to the client device 28, illustrated as the “MESSAGE ALERT” in FIG. 4 or an additional destination, such as a mobile phone, indicating that the display succeeded or failed. If the display fails, the reason for the failure may be indicated, such as printer out of paper or ink and/or offline. The client device 28 illustrated in FIGS. 4-5 is representative of a plurality of client devices 28 to which the status message can be sent, including additional status messages to independent devices, such as mobile phones, tablets, web browsers, and/or email clients.

The display system 26 typically responds to the display instruction 1100 with a status message, illustrated as response 7. The status message confirms that the display instruction 1100 was successfully received and/or provides information related to any errors in transmission of the display instruction 1100. After receipt of the status message in response 7, the request unit 12 transmits or forwards the status message to the client device 28 illustrated as response 8. The status message may then be interpreted by the client device 28 and/or provided to the user 49. The status message may be provided to the user 49 as, for example, a synchronous message via a confirmation page on a web browser of a user interface 48.

In addition to and/or in combination with the above examples, at least one of the content service 44, the resource broker 14, the request unit 12, and the display system 26 may produce an error message. The error(s) may be cascaded down the response chain to the client device 28 for synchronous presentation to the user 39. The error message may indicate that the display request 600 could not be accepted and the reason that the display request 600 could not be accepted. Examples include the content resource 23 or service resource 24 being unavailable, permission denied, display system 26 not found, and/or display settings 63D are invalid. Moreover, the error message can include a feature such as, hyperlinks or virtual buttons, to allow the user 49 to initiate transmission of another display request 600. For example, the user 49 may be provided with suggested syntax, alternate resources, an interface for obtaining permissions, suggested display systems 26, and/or valid display settings using an actuation feature, such as selection buttons on the user interface 48.

In FIGS. 4-5, the display request 600 originates from the client device 28 (request 1). The client device 28 may obtain the information for composing or assembling the display request 600 based on prior user interactions with the resource broker 14. FIG. 12 is a block diagram illustrating how the system 100 allows a user 49 to interact with a user interface 48 of the client device 28 as a fully functional control for selecting parameters corresponding to a content resource 63A, manipulating the representation of the content with a service resource 63B, and selecting parameters corresponding to a display system 63C and display settings 63D. FIG. 13 is a sequence diagram corresponding to FIG. 12.

Referring to FIGS. 12-13, A the user 49 via the user interface 48 of the client device 28 may request an application code, such as HTML, CSS JavaScript code from the resource broker 14 to form the display request 600 as illustrated in FIG. 6. The application code may form new display requests 600 and/or provide the client device 28 if display requests 600 that were previously formatted. The requests and responses illustrated in FIGS. 12-13 may represent significantly reduced data transfer compared to server side components that may transfer full-resolution data for a final print.

The resource broker 14 receives request A from the client device 28. Request A identifies the content resource 23 from a data store, such as parameters corresponding to the content resource 63A. The resource broker 14 transmits a request B to the content resource 23 and response C transmits the requested representation of the content to the resource broker 14. Request B may be a request for a reduced representation of the content, such as a thumbnail version of an image; accordingly, response C will include the thumbnail version of the image instead of the full resolution image. The resource broker 14 concatenates the parameter corresponding to the content resource 63A with application code and transmits a response D to the client device 28. The resource broker 14 may make additional requests to obtain the application code prior to providing it to the user agent.

The client device 28 may execute the application code concatenated with the parameter corresponding to the content resource 63A to provide the user interface 48 with an editing control, such as a hyperlink. For example, the user interface 48 can make available an enhancement operation that is automatic in nature, and provide a simple hyperlink to allow the user to select this control option. Selection of the hyperlink causes the Request E to be received by the resource broker 14. The resource broker 14 transmits request F to the service resources 24 to identify the content resource 63A and the service resource 63B to form a representation of the content with manipulations according to the instructions provided by the service resource 24. The resource broker 14 may then receive a thumbnail version of the representation of the content with any manipulations in response G, which the resource broker 14 will transmit to the user interface 48 of the client device 28 as response H.

The user interface 48 may provide further editing control requiring the user 49 to provide an additional parameter. For example, the user interface 48 may make available an image cropping operation that requires a rectangular region of interest to be selected using an image selection tool on the user interface 48. Multiple iterations of editing via interactions with the user interface 48, each additional processing selection will be concatenated to the display request 600 (i.e., URI).

When satisfied with the editing or processing result that corresponds to the parameters of the content resource 63A and a service resource 63B, the user 39 can initiate request I. The request unit 12 receives request I which provides the parameters corresponding to the content resource 63A and manipulation and to request for the application code. The request unit 12 transmits a response J that provides the requested application code for the user interface 48 to execute. Similarly, the user interface 48 negotiates identification of a display system 26 and display settings 63D and transmits the request to the request unit 12. The request unit 12 receives a request K and composes a response L with the request application code for the user interface 48 to execute. The user interface 48 then may assemble and transmit the display request 600 (request 1 in FIGS. 4-5). For example, the display request 600 may be provided to the user via an actuation function, such as a selection button and/or a web address on a user interface 48.

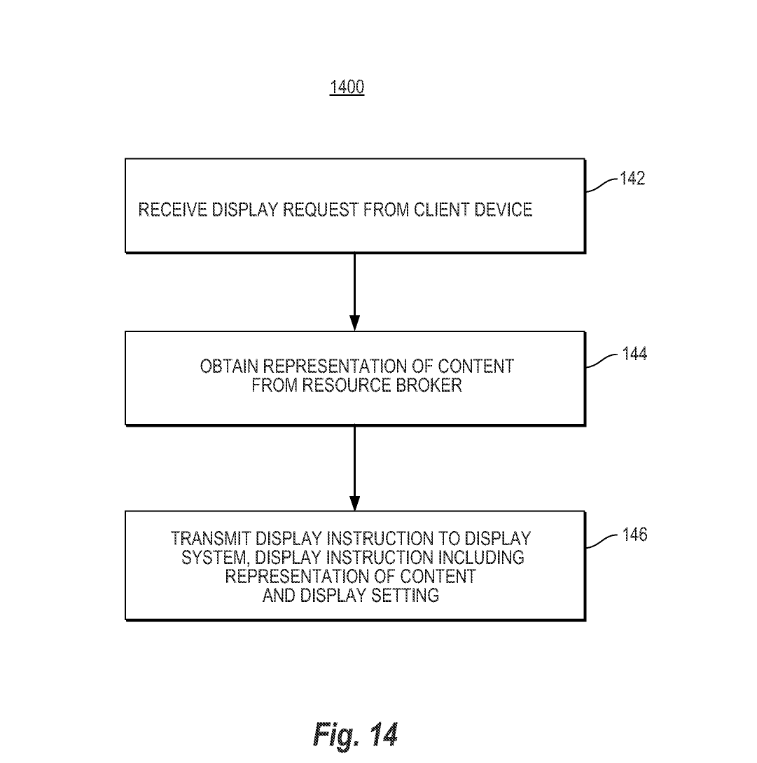

FIG. 14 illustrates a method 1400 to display content according to an example. The method 1400 is useable with a request unit 12. In block 142, the request unit 12 receives a display request 600 from a client device 28. The display request 600 including parameters corresponding to a content resource 63A, a display system 63C, and a display setting 63D, and optionally, a service resource 63B and/or an asynchronous message instruction. The request unit 12 and the resource broker 14 are connected in block 144 to obtain a representation of the content from the resource broker 14. The representation of the content is obtained from the resource broker 14 by transmitting a content request 700 to the resource broker 14. The content request 700 may be composed by the request unit 12 and includes the parameters corresponding to the content resource 63A and the service resource 63B.

In response to the content request 700, the request unit 12 receives the representation of the content from the resource broker 14. The representation of the content is based on the content request 700. The resource broker 14 may obtain the representation of the content with manipulations instructions provided by a service resource 24 based on the parameters corresponding to the content resource 63A and the service resource 63B. The representation of the content with manipulations according to parameters from the content request may be contained within a message 1000 with the representation of the content from the resource broker 14. For example, the message 1000 with the representation of the content may be an HTTP response that includes a status line 92, a message header 64, and a message body 68 having the representation of the content.

In block 146, the request unit 12 transmits a display instruction 1100 to a display system 26 identified in the display request 600. The display instruction 1100 includes the representation of the content and the display setting 63D. After the display instruction 1100 is transmitted, the request unit 12 receives a status message from the display system 26 (response 7). The status message is then transmitted by the request unit 12 to the client device 28 (response 8). For example, the status message may be sent to a user interface 48 connected to the client device 28. Moreover, the status message may be sent via an asynchronous method, such as via a text message or email provided in the message instruction.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. An apparatus to control display of a content between a client device and a display system, the apparatus comprising:
a client engine connected to a client device to receive a display request therefrom, the display request including a set of parameters corresponding to a content resource, a display system, and a display setting;
a resource engine connected to a resource broker to:
transmit a content request to the resource broker, the content request including the set of parameters corresponding to the content resource to obtain a representation of the content from the content resource, and
receive the representation of the content from the resource broker;
a display engine connected to the display system to transmit a display instruction to the display system, the display instruction including the representation of the content and the set of parameters corresponding to the display setting; and
a control unit connected to the client engine, the resource engine, and the display engine to compose the content request and the display instruction.

2. The apparatus of claim 1, wherein the control unit extracts the set of parameters from the display request to compose the content request and the display instruction.

3. The apparatus of claim 1, wherein the set of parameters further comprise a service resource corresponding to an instruction for the service resource to manipulate the content resource to obtain the representation of the content.

4. The apparatus of claim 1, wherein the set of parameters further comprises an asynchronous message instruction.

5. The apparatus of claim 1, wherein at least one of the display request, the content request, and the display instruction comprises a Hypertext Transfer Protocol message.

6. The apparatus of claim 1, wherein the control unit adjusts at least one of the set of parameters corresponding to the content resource, the display system, and the display setting to compose at least one of the content request and the display instruction.

7. A system useable with a client device and a display system, the system comprising:
a resource broker to obtain a representation of a content from a content resource; and
a request unit to control display of the representation of the content from the content resource, the request unit comprising:
a client engine connected to a client device to receive a display request therefrom, the display request including a set of parameters corresponding to the content resource, the display system, and a display setting;
a resource engine connected to a resource broker to:
transmit a content request to the resource broker, the content request including the set of parameters corresponding to the content resource to obtain the representation of the content, and
receive the representation of the content from the resource broker;
a display engine connected to the display system to transmit a display instruction to the display system, the display instruction including the representation of the content and the set of parameters corresponding to the display setting; and
a control unit connected to the client engine, the resource engine, and the display engine to:
extract the set of parameters to compose the content request and the display instruction, and
compose the content request and the display instruction using the set of parameters.

8. The system of claim 7, wherein the resource broker obtains the representation of the content from a content service.

9. The system of claim 8, wherein the set of parameters further comprises a parameter corresponding to a service resource associated with the content service.

10. The system of claim 9, wherein the content service manipulates the representation of the content according to instructions contained in the set of parameters corresponding to the service resource.

11. The system of claim 7, wherein at least one of the display request, the content request, and the display instruction comprises a Hypertext Transfer Protocol message.

12. The system of claim 7, wherein the content request is composed based on negotiations between the request unit and the resource broker.

13. The system of claim 7, wherein the display instruction is composed based on negotiations between the request unit and the display system.

14. The system of claim 7, wherein the set of parameters further comprises a parameter corresponding to an asynchronous message instruction to contact a user, the asynchronous message including at least one of:
a completion message in response to a determination that the display system has executed the display instruction,
an error message in response to a determination that the display system failed to execute the display instruction, and
an actuation feature for initiating a display request with at least one of the set of parameters modified.

15. The system of claim 7, wherein the display engine receives a status message providing a status of the display request from the display system, the control unit provides the status message to the client engine, the client engine transmits the status message to the client device, the status message including at least one of:
an acceptance message in response to a determination that the display system can execute the display instruction,
a denial message in response to a determination that the display system cannot execute the display instruction, and
an actuation feature for initiating a display request with at least one of the set of parameters modified.

16. The system of claim 7, wherein the request unit provides the client device with an actuation feature to adjust at least one of the set of parameters of the content request.

17. The system of claim 7, wherein the display request is composed by the resource broker based on interaction between the client device and the resource broker, the resource broker providing to the client device with an actuation feature to transmit the display request to the request unit.

18. A method to display a content useable with a request unit, the method comprising:
receiving, with the request unit, a display request from a client device, the display request including a set of parameters corresponding to a content resource, a display system, and a display setting;
obtaining a representation of the content from the resource broker by:
transmitting, with the request unit, a content request that includes identifies the content service to the resource broker, and
receiving, with the request unit, a representation of the content from the content service; and
transmitting, with the request unit, a display instruction to a display system, the display instruction including the representation of the content and the display setting.

19. The method of claim 18, further comprising providing a status message to the client device, such that the request unit:
receives the status message from the display system; and
transmits the status message to the client device.

20. The method of claim 18, wherein the resource broker obtains the representation of the content from a content resource.
